(19) United States
(12) Patent Application Publication
(10) Pub. No.: US 2004/0141055 A1
(43) Pub. Date: Jul. 22, 2004

(54) Platform for CCTV

(76) Inventors: Daniel Roberto Losito, Ciudad de Buenos Aires (AR); Guillermo Silvio Svagelj, Ciudad de Buenos Aires (AR)

Correspondence Address: GOTTLIEB RACKMAN & REISMAN PC, 270 MADISON AVENUE, 8TH FLOOR, NEW YORK, NY, 100160601

(21) Appl. No.: 10/387,084

(22) Filed: Mar. 12, 2003

(30) Foreign Application Priority Data
Mar. 14, 2002 (AR) P 020100912

(51) Int. Cl. H04N 7/18

(52) U.S. Cl. 348/143

(57) ABSTRACT

A mobile platform for closed circuit television cameras includes a transportation rail for movement of the camera in relation to an initial fixed position. An electronic circuit control is provided for controlling the displacement of the platform on the rail. The rail is designed to have various shapes to allow compatibility with different types of the television cameras and to allow panoramic shots at the variable angles of inclination.

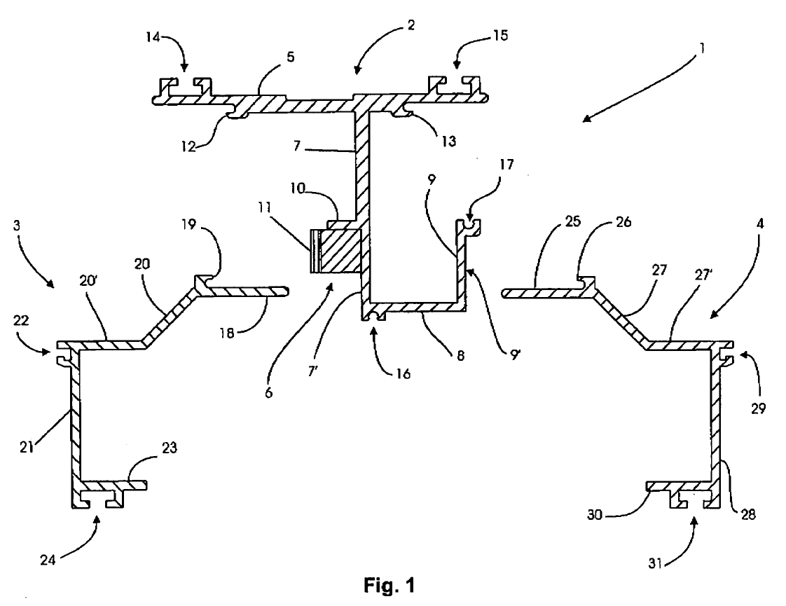

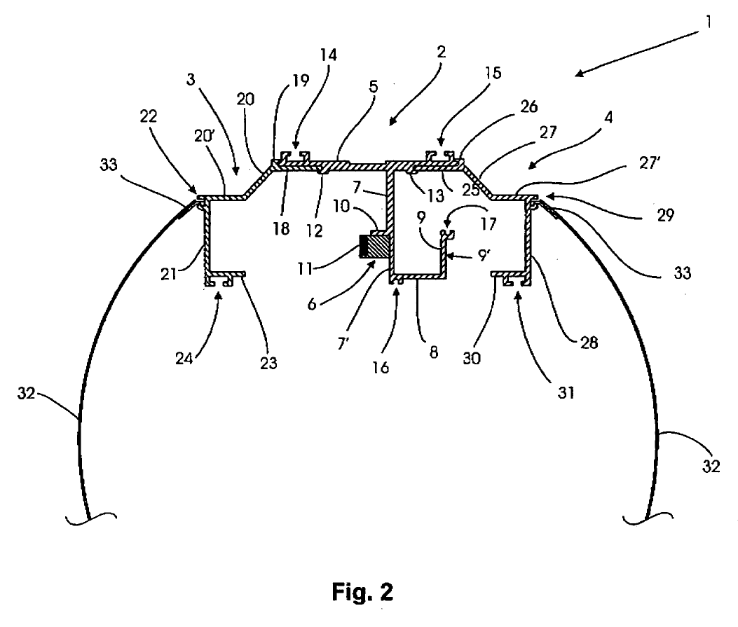

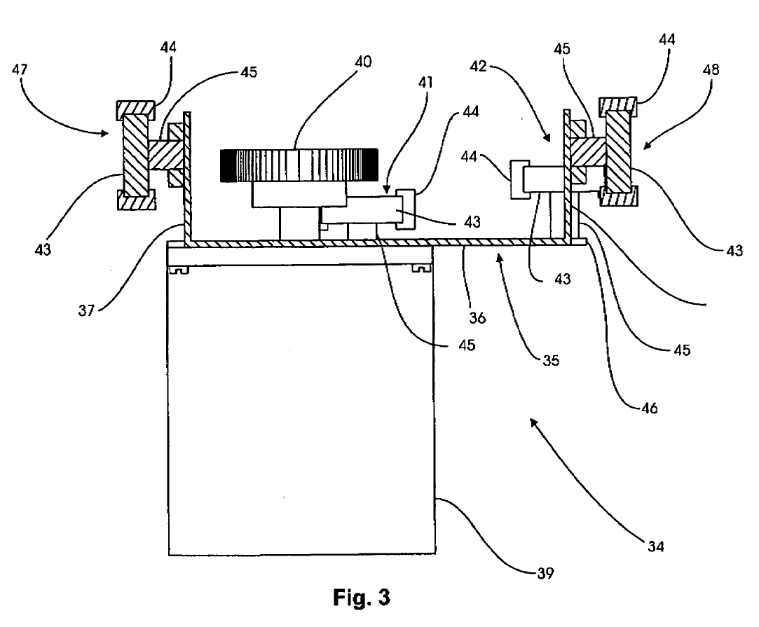

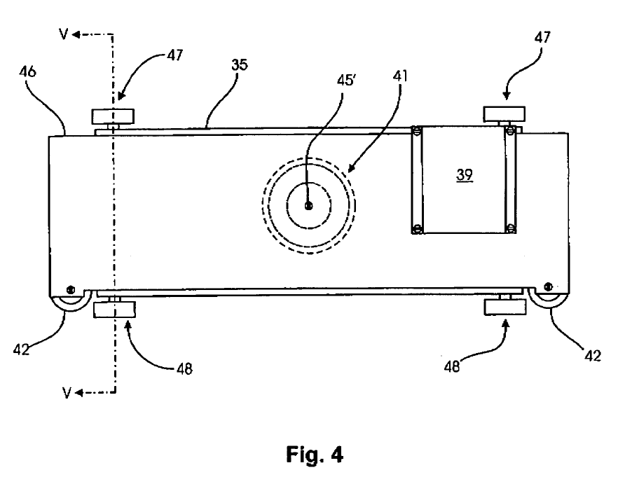

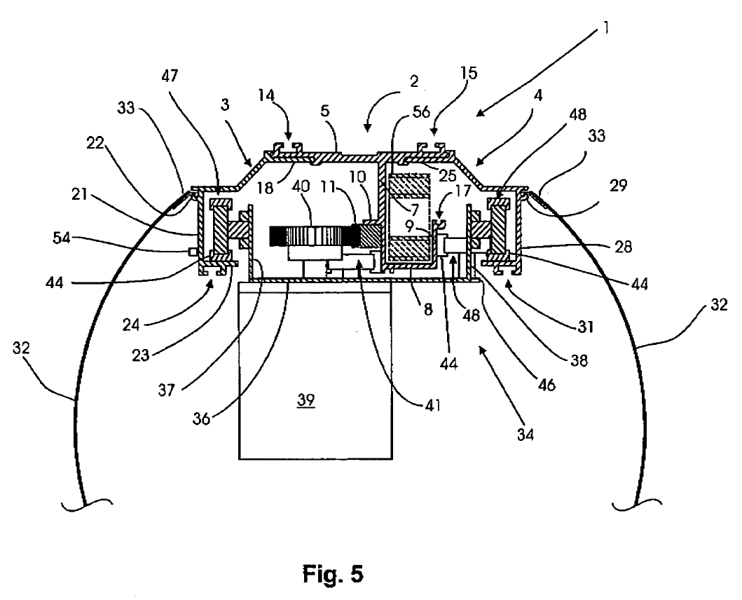

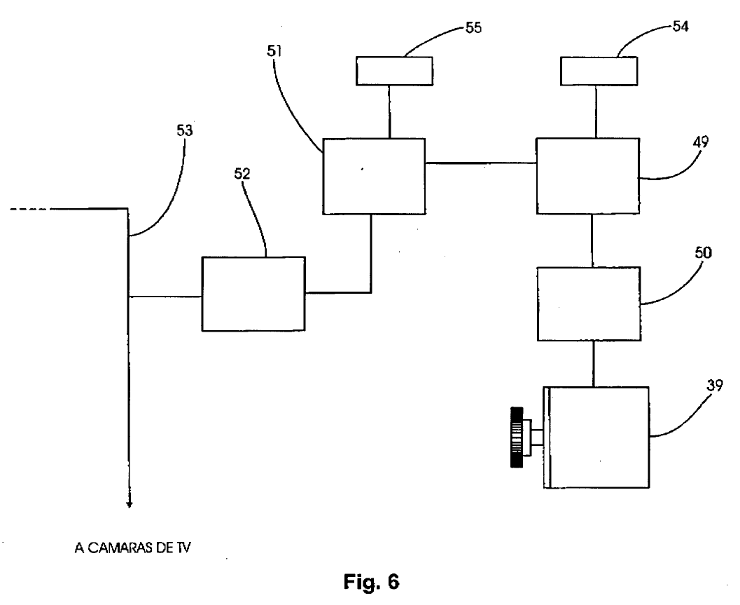

### FIELD OF THE INVENTION

This invention refers to a mobile platform for closed circuit television cameras, a rail for the placing and displacement of said platform and to an electronic circuit to control the displacement of the platform on the rail. More specifically, the invention refers to a platform placed on a transportation rail that carries the television cameras; its structural and functional special characteristics allow the movements of television cameras of different types and origin, which are placed in the rail along which they displace whether this rail is straight or curvilinear, to make panoramic shots of 360° and variable angles of inclination at grater speeds than those which are possible with the platforms and cameras known up to the present.

### BACKGROUND OF THE INVENTION AND PROBLEMS TO BE SOLVED

Up to the present, several types or groups of closed circuits television cameras are known such as fixed cameras, “pan and tilt”-kind cameras, “domo”-kind cameras and “domo displaceable”-kind cameras.

First of all it is worth mentioning that the fixed cameras do not allow the possibility of controlling any kind of movement and only include special lens from which the “zoom” of the mentioned lens can be controlled in a remote manner.

Regarding “pan and tilt”-kind cameras, they include platforms that have the characteristic of making panoramic shots of 360° and tilt in variable angles, which magnitude depends on each manufacturer of these cameras. On said platform, a fix camera is placed which can be moved and can focus at will.

By its own, “domo”-kind cameras are similar to the previous ones but these are smaller, they posses grater speeds of panoramic shots and inclinations and have an integrated zoom.

Finally, “domo displaceable”-kind cameras combine the functions of “domo” cameras with the possibility of displacing by a rail both straight and curvilinear.

Among the inconveniences that present this types of cameras, it is worth pointing up the incompatibility among the models provided by different manufacturers of closed circuit television equipments, as each one provides cameras with different communication protocols and besides, few interfaces between the protocols not always are sufficiently effective. On the other hand, platforms for mobile cameras known in the previous art work in this regard, present inconveniences such as those originated by the effects of friction, vibrations and errors of displacement caused by the interaction of the wheels of the camera-carrier carriages and the rails on which these wheels rest. In this sense, for instance, the rail and the mobile platform provided by Sentry Technology Corporation, in which the camera-carrier carriage of said platform has sets of wheels located in a horizontal manner and work by friction against the support walls in the profile along which the platform displaces can be mentioned. These wheels are in charge both of the necessary mechanical transmission for the movement of the rail as well as of the registry of said movement. One of the disadvantages of this mechanism, in comparison with the platform of this invention, is that it uses a greater quantity of mobile parts and a position decoder, which increases the possibilities of error and failures in the functioning.

Unlike the platform of the previous art work before mentioned and such as it shall be seen hereinafter, the camera-carrier carriage which is part of this invention, includes a rack and a pinion associated to it in order to produce the displacement of the carriage, reason why no friction forces that affect the transmission of the movement appear. Another important difference is that a decoder is not required, as the position is determined by forward and backwards movements of the already mentioned “step by step” engine.

Another inconvenience detected in the existing equipments is the level of noise produced by the functioning. In the proposed invention, the level of noise was reduced by using a minimum quantity of mobile parts and a “step by step” engine without reduction.

In accordance with the previously expressed, this invention has been developed in order to provide a platform for the placement of the cameras provided by different manufacturers, with a control totally independent of the movement of said platform and without requiring the participation in communication protocols of different closed circuit television cameras, except for the choosing of the rail to be used in case of existing more than one. For that purpose, said platform is joined to a rail and to an electronic control circuit specially developed.

### BRIEF DESCRIPTION OF THE INVENTION

The aim of this invention is achieved by means of a rail that supports and guides the longitudinal movement of the carriage by means of a non-fed circuit for the control of the position and speed. The closed circuit television camera or cameras and all the electronic devices to operate it are placed in said carriage. The rail is made of extruded aluminium profiles, having each section of the rail a length of 3 meters approximately. These sections of the rail are joined to form a rail that may measure up to 50 meters approximately, in accordance with one of the preferred fulfillments of this invention. The final length will depend on the dimensions of the place where the cameras are to be installed and used. The electronic equipments of control have a minimum relation with the basic closed circuit television system, and it is only necessary to pick up the signal of the data of the “domos” if there exists more than one mobile device. In this case, an interface capable of decoding the data is needed, but only to know the direction of the camera that is being called. The rest of the process is totally independent; this means that it is separated from the point of view of the control of the basic closed circuit television system.

The movement is achieved by a “step by step”-kind engine so as not to need re- feeding in relation to the movement. This engine has a pinion joined to a rack united to the rail. The purpose of this rack is to eliminate the slide between the wheels of the carriage and the profile or rail and the consequent negative effects of the produced friction. Should that not be the case, it would be necessary to have movement sensors and encoders, causing the loop to be re-fed for the position and the speed, and more complex control equipments with more mobile parts would be needed, and therefore, there exists more possibility of error. The electric link is by means of a cable hanger chain. Besides, an external coating of polycarbonate is included, which may be semi-translucent or translucent with a semi-translucent film, which obstructs the discovering of the location of the carriage and its direction from the outside, and besides, it provides a mechanical protection.

To place the carriage in an initial position in relation to a reference when turning the equipment on, end travel sensors which are placed in one of the extremes of the rail are used. Under this conditions, when the cycle of the functioning of the equipment starts, the carriage automatically searches said sensors and determines an extreme point named “start”. Once the start point is reached, a value equal to cero is assigned to that position in a counter placed in the controlling circuit of all the process. Every step of the engine implies the adding of a unit in the counter which is the one that determines the real position of the carriage. The maximum quantity in that counter is entered to the program of the controller by software and it is directly proportional to the length of the rail.

Therefore, one of the purposes of this invention is to provide a mobile platform for closed circuit television cameras, of the kind defined by a carriage that carries at least one television camera capable of being rotated and angularly moved in relation to a fixed position, upon which said carriage is placed on a rail along which it can displace, and the platform and the camera are connected to movement control circuits which include a handling lever device “joystick”-kind, where the mentioned carriage has a frame in which the “step by step” engine of transmission of the carriage displacement force is placed and on its axle is placed a pinion operatively coupled to a rack fixed along the rail and a set of main resting-wheels of the carriage on said rail as well as a set of wheels which stabilize the direction of the movement of the carriage are coupled to said frame.

It is also a purpose of this invention to provide a rail for the placing and displacement of the platform hereinbefore defined, which includes a central profile and a pair of symmetric lateral profiles which can be attached to the mentioned central profile; the central profile presenting a horizontal portion under which an inferior partition projects; in said partition, the opposite lateral surfaces upon which said stabilizer direction wheels respectively rest are defined.

It is also a purpose of this invention to provide an electronic circuit to control the movements of the platform and cameras placed in this platform in accordance with the preceding vindications, where said electronic circuit has a programmable logical controller or PLC which is connected from one side to a circuit that excites said “step by step” engine and, from the other side, to the control lever device, or “joystick”, which is connected, by means of a interface circuit, to a line of transmission of the data corresponding to the movements to be done, and this programmable logical controller has an input connected to end travel sensors, whereas this control lever device is connected to input circuits of failures alarm. When any of the alarm circuits sends the corresponding signal, this signal is interpreted by the control circuit to place the carriage in a pre-established location convenient to have an optimal point of view of that alarm event.

### BRIEF DESCRIPTION OF THE PICTURES

For grater clarity and comprehension of the purpose of this invention, it has been illustrated in several pictures, in which this invention has been represented in one of its preferred placing methods, to be taken as examples, where:

Picture 1 is a cross section view and a view “per pieces” of a rail formed by profiles which can assemble among each other in accordance with this invention;

Picture 2 is a cross section view of the rail of Picture 1, now illustrated with said profiles already assembled, and a protective cover coupled to it is also shown, but partially;

Picture 3 is a partially sectional, cross section view of a camera-carrier carriage which is assembled to the rail illustrated in Pictures 1 and 2;

Picture 4 is an inferior view of the carriage illustrated in Picture 3;

Picture 5 is a transversal view, according to view V-V of the Picture 4, which shows the carriage of Pictures 3 and 4 assembled to the rail of Pictures 1 and 2; and

Picture 6 is a block diagram of the electronic circuit used to control the movements of the platform of this invention, and an engine connected to this circuit is also shown.

### DETAILED DESCRIPTION OF THE INVENTION

First of all and in relation to Picture 1, a rail 1 made up of a central profile 2 is shown, substantially horizontal, and of symmetrical lateral profiles 3 y 4. The central profile 2 shows a horizontal portion 5 under which a kind of inferior partition is projected 6 which presents a first section 7, substantially perpendicular to portion 5, a second section 8, substantially parallel to said portion 5, and a third section 9, of shorter length than section 7 and substantially parallel to it. From an approximately medium point of section 7, and in opposite direction to section 8, a small wing 10 projects that defines a stop for the fixing of a rack 11 which extends along the profile 2. In the sections of the portion 5 which extends to one side and to another with respect to section 7 of the inferior partition 6, profile 2 presents respective fittings 12 y 13 for the coupling of lateral profiles 3 y 4. Close to the opposed lateral borders of portion 5, profile 2 includes the respective superior longitudinal assembly guides 14 and 15. Sections 8 and 9 of the inferior partition 6 include respective locations 16 and 17 for guides of a cable hanger chain 56.

On another hand, lateral profile 3 presents a superior small wing 18 with fitting 19 for its coupling with profile 2 in the portion of its fitting 12. Following this small wing 18, sections 20-20′ which form an angular cross section can be observed and, in the point where sections 20′ and 21′ join, which is perpendicular to the one before mentioned, profile 3 presents a pair of projections which define a cavity of support 22 for the fixing of an external coating 32 from its corresponding border 33. As it has been explained, said coating 32 is preferably made of polycarbonate, semi-translucent or translucent with a semi-translucent film, and its purpose is to avoid the location and direction of the carriage that transports the television cameras from being noticed from the outside, as well as to offer mechanical protection to the group of elements placed in its interior. In the lower part, profile 3 ends in a small wing 23 that defines one of the slides for the displacement of the camera-carrier carriage illustrated in Picture 3. Beneath this small wing 23 an inferior guide 24 is formed. Similarly to profile 3, profile 4 has a superior small wing 25 with fitting 26 for its coupling with profile 2 in its portion of the fitting 13, sections 27-27′ and a section 28, in its meeting point with section 27′ from which a pair of projections that define a cavity of support 29 for the fixing of border 33 corresponding to the external coating 32 are projected. In the inferior part, Profile 3 ends in a small wing 30 that defines other of the slides used for the displacement of the camera-carrier carriage illustrated in Picture 3. Underneath this small wing 30 an inferior guide 31 is formed. The purpose of guides 24 and 31 shall be explained hereinafter.

In Picture 2 the coupling of profiles 3 and 4 with profile 2 to form rail 1 is shown, upon which the carriage illustrated in Picture 3 is placed and can be displaced and which shall transport one or more television cameras, as it will be explained hereinafter when referring to Picture 4. The nominal length of a complete rail to be used formed by a succession of rails 1 joined to each other, that vary in accordance with the requirements of the installation, is estimated in 50 meters approximately, in accordance with a typical example of application.

In Picture 3 a carriage in agreement with this invention is shown, indicated with the reference number 34, that includes a main frame 35, of cross section in “U” shape, which has an inferior wall or base 36 and lateral walls 37 y 38. Underneath the inferior wall 36 of the frame 35 a “step by step”-kind engine 39 is fixed, which transmits the displacement force without the necessity of reductions; its axle projecting above base 36 and in which a pinion 40 is coupled. Parallel to base 36, close to pinion 40, a first direction wheel 41 is placed, whereas, close to the border of the base 36 of the frame 35 corresponding to the lateral wall 38 a second direction wheel 42 is placed, also parallel to base 36. Wheels 41 and 42 form a set of wheels stabilizers of the direction of movement of the carriage 34. In the lateral walls 37 and 38 of the frame 35 and parallel to them, main wheels 47 and 48 that rest on a rail 1 and allow the soft displacement of the carriage 34 along it are respectively placed.

Each one of the wheels 41, 42, 47 and 48, have a ball bearing 43 with a perimeter rubber covering 44. Wheels 41 and 42 are fixed to a wheel-carrier frame 46 by means of its respective axles 45, whereas wheels 47 and 48 are fixed to lateral walls 37 and 38. The wheel-carrier frame 46 is in turn fixed to the main frame 35. Please note that the bearings, the rubber coverings and the axles of wheels 41, 42, 47 and 48 have been indicated with the same reference numbers only to simplify the explanation.

In Picture 4 the location of wheels 41, 42, 47 and 48 can be more clearly observed in relation to the main frame 35 and in relation to the wheel-carrier frame 46. A 45′ bolt that affixes the axle 45 of the direction wheel 41 is also observed. It is worth mentioning, as shown in this Picture 4, the great free surface available for the placing of different kinds of cameras, both fixed and mobile.

In Picture 5 the group defined by rail 1 and the carriage 34 can be observed and, specially, the way in which the pinion 40 couples with the rack 11 to transmit the displacement force of the carriage 34. Given the strength produced by the work of the pinion 41 on rack 11, the transversal stability of the carriage 34 is achieved by means of the direction wheel 41, by resting under the rack 11 on a surface 7′ of the inferior frame 6, and by means of the wheel 42 that rests on a surface 9′ of the section 9 of said frame 6. On the other hand, it is observed that the carriage 34 is supported and can be displaced by rail 1 by means of the slides defined by the small wings 23 and 30 of profiles 3 and 4 respectively, on which the main wheels 47 and 48 rest. The liniality or registry between the small wings 23 and 30 corresponding to successive sections of rail 1 longitudinally coupled, is assured by means of the inferior guides 24 and 31, in which edges that couple the extremes from where the mentioned sections of rail 1 join are inserted. The fixing between consecutive sections of rail 1 may be done, for instance, with threaded small plates placed into the superior guides 14 and 15 and inferior guides 24 and 31, which are adjusted with spring pins.

On the other hand, in rail 1, the perimetric development of partition 6 defines a location cavity for a cable hanger chain 56, placed vertically, which has been drawn in strokes for a greater clarity of the picture. Preferably, this chain 56 is plastic and allows the carriage 34 to electronically connect with profile 1.

The mechanical connection defined by the coupling between the rack 11 and the “step by step” engine 39 allows to solve the serious inconveniences of the devices of similar nature known up to the present, specially in relation to the effects of friction, displacement errors and vibrations produced between the resting-wheels of the carriages and the rails during the functioning of this devices. Besides, these problems demand the use of control circuits re-fed for the permanent transmission of correction signals, what implies a grater complexity, cost and more frequent preventive and/or corrective maintenance works. Instead, the platform of this invention allows a more secure control and without length errors and the displacement speed of the carriage is more reliable regarding its mechanical and electric structure and regarding the used command circuits. Concerning this last feature, it is worth pointing out that in this invention, unlike what happens in the devices of the previous art work in this regard, the control circuit is non-re-fed, what makes more simple, secure and economic its practical implementation.

In the block diagram illustrated in Picture 6, where the engine 39 and the electronic circuit used to command the movement of the platform and the television cameras in accordance with this invention are represented, it is shown that this circuit covers a programmable logical controller or PLC 49 connected from one side to an exciter 50 which controls the engine 39 and, from the other, to a control lever device or “joystick” 51, which is connected, by means of an interface 52, to a data transmission line 53 to the television cameras. Besides, the PLC 49 presents an input which is connected to end travel sensors 54 (see physical location in Picture 5) and the joystick 51 has an input connected to alarm circuits 55 of alarm inputs. When one of the alarm circuits sends the corresponding signal, this is interpreted by the control circuits in order to place the carriage in the established position which is convenient to have an optimal point of view of said alarm event.

From this block diagram it can clearly be said that the final course of the involved signals is the engine 50, which, as it has been said, is “step by step”-kind and presents an important torque. The engine 39 receives from the PLC 40, through the exciter 50, a pulse signal corresponding to the quantity of steps by seconds in which this engine 39 must rotate, and a movement direction signal. The exciter 50 turns the little-reaching control signals which come from PLC 49 into current and tension values necessary for the movement of the engine 39.

The PLC 49 is in charge of several functions, as it is detailed hereinafter:

generates the pulses according to the different required displacing speeds;

saves in its memory the locations of the different “pre-positions”, that is to say, the locations of the positions on rail 1 used to displace in a fast manner the carriage 34 to established positions, to link with the dry contacts inputs, called “of alarm”, and to generate pre-positions sequences with intervals of defined times;

saves in memory the real position of the carriage 34 at every moment, without the need of any kind of re-feeding, except for the travel ends in the first cycle of the functioning of the equipment;

makes the arithmetical operations required to obtain ideal speeds of displacement in relation to the location of the carriage 34 according to an acceleration and deceleration ramp;

keeps the programming for all the functions in its memory.

The travel end sensors 54 are connected to PLC 49 for, in the first task of the equipment, the carriage 34 to displace from the beginning to the end, in order to “count” the quantity of steps existing between the extremes of the course and determine its area of work. After this task, the only purpose of the sensors 54 is the activation of the alarm signals in case of eventual operation failures. This provides the basis for the references that affirm that the normal operation of the equipment is by loop without re-feeding.

The reason why a lever device such as the joystick 51 to send the control signals to the PLC 49, is the convenience of facilitating the use of the equipment to the operator. The PLC 49 also includes circuits in charge of decoding the position of the lever of the joystick 51 for the corresponding signals to be perfectly interpreted. Should two or more separate rails, in which the respective carriages 34 with mobile cameras are placed, be connect, it is necessary to incorporate an interface that indicates which rail has been chosen: rail 1, rail 2 and so forth. This interface is the only equipment that connects, data wise, the displacement cameras systems to the basic system of closed circuit television and is capable of adapting to each brand of the system used.

When connecting the feeding of the electronic circuit of Picture 5, the PLC 49 sends the necessary control signals for the carriage 34 to look for a reference position “start” in one of the extremes of rail 1. The PLC receives two signals which come from contacts located close to each other, for instance to 80 cm., and at the end of rack 11. Once the carriage 34 is already in that position, the value cero is entered in an internal counter of the 49. This counter is the one that accumulates the pulses which are sent to the “step by step” engine 39 and has the position reference for all the movement operations. When this operation is finished, the equipment is in conditions of starting to operate normally. When a movement of the lever of the joystick 51 is made, the amplitude of the movement of said lever is digitalized, as this amplitude is proportional to the displacement speed of carriage 34, and sends the signal of the required speed to the PLC 49 selected in accordance with the number of the selected camera in the original CCTV system adapted by the transcoder. When receiving this signal, the PLC 49 controls the required movement to be valid depending on the position of the carriage 34 and on external alarm signals and calculates the ramps of acceleration in order to answer to the operator's necessities. After this, it calculates the quantity of pulses per second depending on these acceleration and deceleration ramps or constant speed and the exciter 50 is in charge of the translation of those pulses into electric signals capable of energizing the coils of engine 39. Carriage 34 can be displaced to variable and regulated speeds. The operator must program the alarm, use and displacement or “tours” prepositions. They are stored and on the operator's request, when referring to use and “tours” prepositions, carriage 34 locates in those places, or when an alarm contact is closed, the carriage is automatically located, without depending on the work of the joystick 51, until said pre-position has been reached.

Vindications.

Having thus specially described and determined the nature of this invention and the manner in which it shall be put into practice, the following is hereby vindicated as property and exclusive right:

1. Mobile platform for closed circuit television camera, of the kind defined by a carriage which carries at least one television cameras capable of been rotated and angularly moved in relation to a fixed position where the mentioned carriage is placed and can be displaced along a rail, being la platform and the camera connected to movements control circuits that include a handling lever device “joystick”kind, being the platform characterized because this carriage presents a frame where a “step by step” engine of transmission displacement force of the carriage and on its axle is placed a pinion operatively coupled to a rack fixed along the rail, and a set of main resting-wheels of the carriage on said rail as well as a set of wheels which stabilize the direction of the movement of the carriage are coupled to said frame.

2. Mobile platform in agreement to vindication 1, is characterized because this frame includes a main cross section frame in “U” shape and a secondary wheel-carrier frame, substantially flat and fixed under an inferior wall of the main frame, being the axle of a first of said stabilizer wheels fixed onto the middle portion of said inferior wall of the main frame, whereas the axle of a second of those stabilizer wheels is fixed close to a lateral border of this wheel-carrier frame, being these stabilizers wheels operatively related to the mentioned rail.

3. Mobile platform in agreement to vindication 2, characterized because each one of the wheels of a first pair and a second pair of the set of said main resting-wheels of the carriage are fixed, from their respective axles, close to the opposite extremes of lateral walls defined by cross section in “U” shape of the main frame.

4. Mobile platform in agreement to vindications 2 o 3, characterized because the mentioned engine is fixed below the inferior wall of the main frame, and its axle goes through said wall and being said pinion set on the space defined between the lateral walls of the main frame.

5. Mobile platform in agreement to any of the preceding vindications, characterized because each one of said main wheel and said stabilizer wheels are defined by ball bearing that present a rubber perimetric covering.

6. A rail for the placing and displacement of the platform in agreement to the preceding vindication, characterized because includes a central profile and a pair of symmetric lateral profiles and attachable to said central profile, presenting the central profile a horizontal portion under which an inferior partition is projected in which opposite lateral surfaces where the said wheels stabilizers of direction respectively rest are defined.

7. A rail in agreement to vindication 6, characterized because the mentioned partition is defined by a first section, substantially perpendicular to said central portion, a second section, substantially parallel to it, and a third section, of lesser length than the first and substantially parallel to it, projecting from an approximately medium point of the first section, and opposite to the third, a small wing which defines a fixing stop of the mentioned rack, being these opposite lateral surfaces respectively defined by the surface of a portion of the first section which extends under said rack and by the external surface of said section.

8. A rail in agreement to vindication 7, characterized because in the proximities of the lateral borders of the central portion of the central profile, there are formed respective fittings for the coupling of the lateral profiles by means of additional fittings formed in the respective superior longitudinal borders of said fittings.

9. A rail in agreement to any of the vindications 6 to 8, characterized because each of the mentioned lateral profiles, in a border opposite to the coupling with the central profile, ends in the inferior in a substantially horizontal small wing that defined a displacement slides of said carriage and where said main wheels rest.

10. A rail in agreement to vindication 9, characterized because underneath each one of these small wings of lateral profiles and superiorly in said central profile there are formed the respective longitudinal coupling guides among successive profiles, defining said guides the location cavities of fixing threaded small plates of these successive profiles by means of spring pins.

11. A rail in agreement to any of the vindication 7 to 10, characterized because said inferior partition defines a guide location cavity for a cable hanger chain.

12. An electronic circuit to control the displacement of the platform on the rail in accordance with the preceding vindications, characterized because includes a programmable logical controller, or PLC, connected from one side to a circuit that excites the “step by step” engine and, from the other, to the control lever device, or “joystick”, which is connected, trough an interface circuit, to a line of transmission of the data corresponding to the movements to be made, having this programmable logical controller an input connected to travel end sensors, whereas this control lever device is connected to input circuits of failures alarms.

Summary.

Mobile platform for closed circuit television cameras, a rail for the placing and displacement of this platform and electronic circuit to control the displacement of the platform on the rail. The platform is defined by a carriage that includes a main frame, of cross section in “U” shape, where a “step by step” engine is placed, affixed to the base of said “U”, and on its axle, a pinion operatively coupled to a rack fixed along the rail is located. In the lateral walls of the “U” defined by the main frame, resting-wheels of the carriage are located on the rail. The carriage includes a set of wheels stabilizers of the direction of the movement of the carriage, located in parallel direction to the pinion. The rail is defined by a central profile and a pair of symmetrical lateral profiles attachable to the central profile and under which a partition is perpendicularly projected and its perimetric development defines parallel walls that form a location cavity of a cable hanger chain. In the external surfaces of the parallel walls of the partition the stabilizer wheels rest, whereas in one of the walls the rack is fixed. The electronic circuit includes a programmable logical controller connected from one side to an exciter of the “step by step” engine and, from other side, to a control lever device or “joystick”, which is connected, through an interface circuit, to a line of transmission of the data corresponding to the movements to be done. The controller has an entrance connected to end travel sensors and the control lever device is connected to input circuits of failures alarms.

I certify this to be the true and accurate translation into English of the original document in Spanish that I have had before me and to which I beg to refer. In the City of Buenos Aires, Argentine Republic, on this first day of April in the year two thousand and three.

Certifico que la que antecede es traducción fiel al idioma inglés del documents original en idioma español que tuve a la vista y al cual me remito. En la ciudad de Buenos Aires, República Argentina, el primer día del mes de abril del año dos mil tres.

1. Mobile platform for closed circuit television camera, of the kind defined by a carriage which carries at least one television camera capable of been rotated and angularly moved in relation to a fixed position where the mentioned carriage is placed and can be displaced along a rail, being a platform and the camera connected to movements control circuits that include a handling lever device “joystick”—kind, being the platform characterized because this carriage presents a frame where a “step-by-step” engine of transmission displacement force of the carriage and on its axle is placed a pinion operatively coupled to a rack fixed along the rail, and a set of main resting-wheels of the carriage on said rail as well as a set of wheels which stabilize the direction of the movement of the carriage are coupled to said frame.

2. Mobile platform in agreement to claim 1, is characterized because this frame includes a main cross section frame in “U” shape and a secondary wheel-carrier frame, substantially flat and fixed under an inferior wall of the main frame, being the axle of a first of said stabilizer wheels fixed onto the middle portion of said inferior wall of the main frame, whereas the axle of a second of those stabilizer wheels is fixed close to a lateral border of this wheel-carrier frame, being these stabilizer wheels operatively related to the mentioned rail.

3. Mobile platform in agreement to claim 2, characterized because each one of the wheels of a first pair and a second pair of the set of said main resting-wheels of the carriage are fixed, from their respective axles, close to the opposite extremes of lateral walls defined by cross section in “U” shape of the main frame.

4. Mobile platform in agreement to claims 2 or 3, characterized because the mentioned engine is fixed below the interior wall of the main frame, and its axle goes through said wall and being said pinion set on the space defined between the lateral walls of the main frame.

5. Mobile platform in agreement to any of the preceding claims, characterized because each one of said main wheel and said stabilizer wheels are defined by ball bearing that present a rubber perimetric covering.

6. A rail for the placing and displacement of the platform in agreement to the preceding claims, characterized because includes a central profile and a pair of symmetric lateral profiles and attachable to said central profile, presenting the central profile a horizontal portion under which an inferior partition is projected in which opposite lateral surfaces where the said wheels stabilizers of direction respectively rest are defined.

7. A rail in agreement to claim 6, characterized because the mentioned partition is defined by a first section, substantially perpendicular to said central portion, a second section, substantially parallel to it, and third section, of lesser length than the first and substantially parallel to it, projecting from an approximately medium point of the first section, and opposite to the third, a small wing which defines a fixing stop of the mentioned rack, being these opposite lateral surfaces respectively defined by the surface of a portion of the first section which extends under said rack and by the external surface of said section.

8. A rail in agreement to claim 7, characterized because in the proximity of the lateral borders of the central portion of the central profile, there are formed respective fittings for the coupling of the lateral profiles by means of additional fittings formed in the respective superior longitudinal borders of said fittings.

9. A rail in agreement to any of the claims 6 to 8, characterized because each of the mentioned lateral profiles, in a border opposite to the coupling with the central profile, ends in the inferior in a substantially horizontal small wing that defined a displacement slides of said carriage and where said main wheels rest.

10. A rail in agreement to claim 9, characterized because underneath each one of these small wings of lateral profiles and superiorly in said central profile there are formed the respective longitudinal coupling guides among successive profiles, defining said guides the location cavities of fixing threaded small plates of these successive profiles by means of spring pins.

11. A rail in agreement to any of the claims 7 to 10, characterized because said ifterior partition defines a guide location cavity for a cable hanger chain.

12. An electronic circuit to control the displacement of the platform on the rail in accordance with the preceding claims, characterized because includes a programmable logical controller, or PLC, connected from one side to a circuit that excites the “step-by-step” engine and, from the other, to the control lever device, or “joystick”, which is connected, through an interface circuit, to a line of transmission of the data corresponding to the movements to be made, having this programmable logical controller an input connected to travel end sensors, whereas this control lever device is connected to input circuits of failures alarms.
